(19) United States
(12) Patent Application Publication
(10) Pub. No.: US 2017/0015112 A1
(43) Pub. Date: Jan. 19, 2017

(54) IMAGE FORMING APPARATUS, IMAGE FORMING METHOD, AND RECORDING MEDIUM STORING AN IMAGE FORMING PROGRAM

(71) Applicant: Shigeru YOSHIGAI, Kanagawa (JP)

(72) Inventor: Shigeru YOSHIGAI, Kanagawa (JP)

(73) Assignee: Ricoh Company, Ltd., Tokyo (JP)

(21) Appl. No.: 15/210,968

(22) Filed: Jul. 15, 2016

(30) Foreign Application Priority Data
Jul. 15, 2015 (JP) 2015-141558

(51) Int. Cl. B41J 11/00; B41J 2/01

(52) U.S. Cl. CPC B41J 11/008; B41J 2/01; B41J 2202/13

(57) ABSTRACT

An image forming apparatus includes a recording head that records an image on an recording medium by repeating operation of ejecting an ink droplet from a nozzle on the recording medium in a sub-scanning direction, while being moved in a main scanning direction with respect to the recording medium, an edge detector that detects two or more edges in the main scanning direction of the recording medium along the sub-scanning direction, and circuitry that determines a recording area of the recording medium based on a detection result by the edge detector, the recording area being an area where the image is recorded by the recording head.

### CROSS-REFERENCE TO RELATED APPLICATION

This patent application is based on and claims priority pursuant to 35 U.S.C. §119(a) to Japanese Patent Application No. 2015-141558, filed on Jul. 15, 2015 in the Japan Patent Office, the entire disclosure of which is hereby incorporated by reference herein.

### BACKGROUND

Technical Field

The present invention relates to an image forming apparatus, an image forming method, and a non-transitory recording medium storing an image forming program.

Background Art

Recently, image forming apparatuses such as printers and facsimiles used for outputting digitized information have become indispensable. Among those image forming apparatuses, image forming apparatuses that perform printing using an inkjet method (hereinafter referred to as “an inkjet printer”) are known. In printing, the inkjet printer, which includes a carriage provided with recording heads, repeats operation of ejecting ink from nozzles formed on the recording heads on a recording medium in the sub-scanning direction, while scanning the carriage in the main scanning direction against the recording medium.

There is also an inkjet printer that can perform so-called frameless printing, which prints an image over the recording medium so that there is no margin on a frame of the recording medium.

### SUMMARY

Example embodiments of the present invention provide a novel image forming apparatus includes a recording head that records an image on an recording medium by repeating operation of ejecting an ink droplet from a nozzle on the recording medium in a sub-scanning direction, while being moved in a main scanning direction with respect to the recording medium, an edge detector that detects two or more edges in the main scanning direction of the recording medium along the sub-scanning direction, and circuitry that determines a recording area of the recording medium based on a detection result by the edge detector, the recording area being an area where the image is recorded by the recording head.

Further example embodiments of the present invention provide a method of forming an image and a non-transitory recording medium storing an image forming program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating an image forming system as an embodiment of the present invention.

FIG. 2 is a diagram illustrating an inside configuration of an inkjet printer from a direction perpendicular to a recording surface as an embodiment of the present invention.

FIG. 3 is a block diagram illustrating a hardware configuration of the inkjet printer as an embodiment of the present invention.

FIG. 4 is a block diagram illustrating a functional configuration of the inkjet printer as an embodiment of the present invention.

FIG. 5 is a flowchart illustrating an operation that the inkjet printer performs frameless printing as an embodiment of the present invention.

FIG. 6 is a flowchart illustrating an operation that the inkjet printer performs frameless printing as an embodiment of the present invention.

FIG. 7 is a flowchart illustrating an operation that the inkjet printer performs frameless printing as an embodiment of the present invention.

FIG. 8 is a flowchart illustrating an operation that the inkjet printer performs frameless printing as an embodiment of the present invention.

FIG. 9 is a flowchart illustrating an operation that the inkjet printer performs frameless printing as an embodiment of the present invention.

FIG. 10 is a diagram illustrating an operation that the inkjet printer performs frameless printing as an embodiment of the present invention.

FIG. 11 is a diagram illustrating an operation that the inkjet printer performs frameless printing as an embodiment of the present invention.

FIG. 12 is a diagram illustrating an operation that the inkjet printer performs frameless printing as an embodiment of the present invention.

FIG. 13 is a diagram illustrating an operation that the inkjet printer performs frameless printing as an embodiment of the present invention.

FIG. 14 is a diagram illustrating an operation that the inkjet printer performs frameless printing as an embodiment of the present invention.

FIG. 15 is a diagram illustrating a screen for configuring printing provided by a printer driver as an embodiment of the present invention.

FIG. 16 is a diagram illustrating a screen for configuring a tilt calculating function displayed on a control panel by the inkjet printer as an embodiment of the present invention.

FIG. 17 is a diagram illustrating an operation that the inkjet printer performs frameless printing as an embodiment of the present invention.

FIG. 18 is a diagram illustrating an operation that the inkjet printer performs frameless printing as an embodiment of the present invention.

FIG. 19 is a diagram illustrating an operation that the inkjet printer performs frameless printing as an embodiment of the present invention.

FIG. 20 is a diagram illustrating an operation that the inkjet printer performs frameless printing as an embodiment of the present invention.

FIG. 21 is a flowchart illustrating an operation that the inkjet printer performs frameless printing as an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

A more complete appreciation of the disclosure and many of the attendant advantages thereof will be readily obtained as the same becomes better understood by reference to the following detailed description when considered in conjunction with the accompanying drawings.

Embodiments of the present invention are described below in detail with reference to figures. In figures, same symbols are assigned to same or corresponding parts, and their descriptions are simplified or omitted appropriately.

In the known technology, since it is required to scan the carriage always detecting an existing area of the recording medium, heavy processing load is burden on the inkjet printer that performs frameless printing.

In the first embodiment, as an example of an image forming apparatus, an image forming apparatus that performs printing using an inkjet method that includes a carriage and recording heads in the carriage and performs printing repeating ejecting ink in the sub-scanning direction from nozzles formed on the recording heads on a recording medium scanning the carriage in the main scanning direction against the recording medium (i.e., the inkjet printer) is described.

In addition, in this embodiment, the inkjet printer can perform so-called frameless printing that prints an image over the recording medium so that there is no margin on a frame of the recording medium.

In this embodiment, in performing frameless printing, the inkjet printer detects edges in the main scanning direction of the recording medium for more than two edges in the sub-scanning direction and determines a printing area based on the detection result.

More specifically, in performing frameless printing, the inkjet printer in this embodiment estimates a tilt of the recording medium by detecting edges in the main scanning direction of the recording medium for more than two edges in the sub-scanning direction and determines the printing area based on the estimated tilt.

As a result, it is unnecessary that the inkjet printer in this embodiment always scans the carriage detecting an area where the recording medium exists. Consequently, it is possible that the inkjet printer in this embodiment reduces the processing load in performing frameless printing.

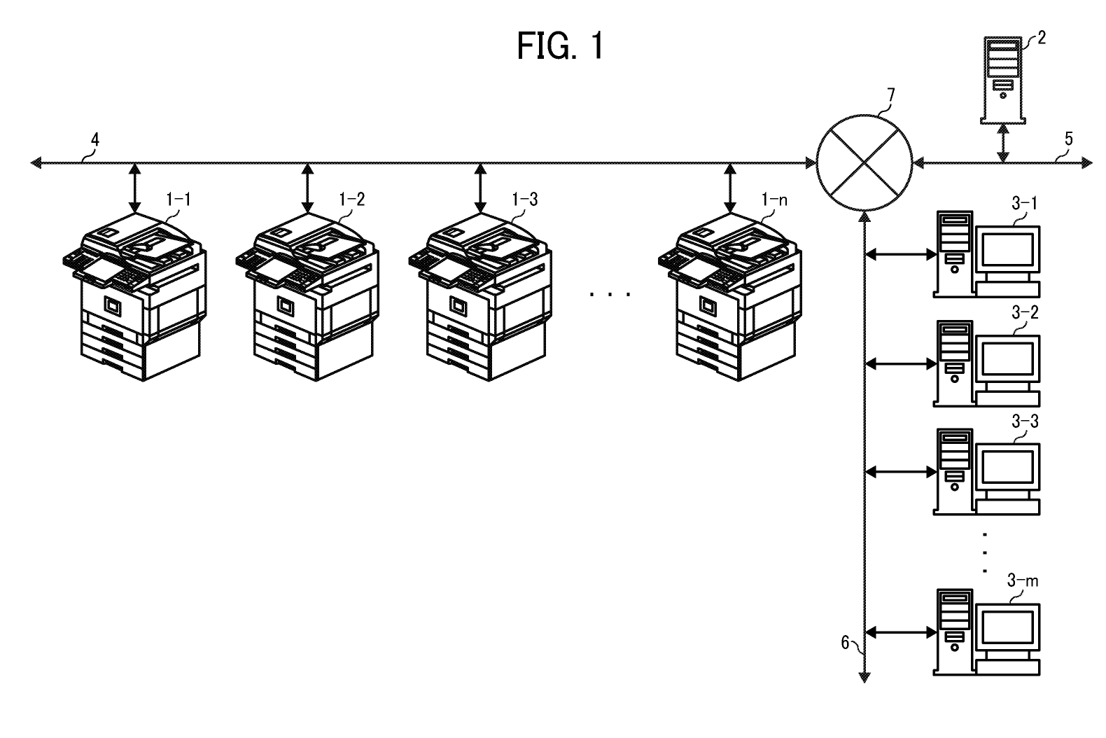

First, operation of an image forming system in this embodiment is described below with reference to FIG. 1. FIG. 1 is a diagram illustrating an image forming system in this embodiment.

As illustrated in FIG. 1, in the image forming system in this embodiment, a network 4 that the inkjet printers 1-1 to 1-n (i.e., n is a natural number) are connected, a network 5 that a print server 2 is connected, and a network 6 that client terminals 3-1 to 3-m (i.e., m is a natural number) are connected are connected with each other via the Internet or a public network such as a telephone network etc.

In the below description, if it is unnecessary to distinguish each of the inkjet printers 1-1 to 1-n respectively, those inkjet printers are collectively referred to as an inkjet printer 1. Likewise, if it is unnecessary to distinguish each of the client terminals 3-1 to 3-m respectively, those client terminals are collectively referred to as a client terminal 3.

The numbers of the inkjet printer 1 connected to the network 4 and the client terminals 3 connected to the network 6 are just examples, and it is possible to connect more number of apparatuses in a larger system. In addition, it is possible that multiple networks that connect different inkjet printer 1 respectively are connected to the print server 2 and the client terminal 3 via the public network 7.

In addition, it is possible that multiple networks that connect different client terminal 3 respectively are connected to the inkjet printer 1 and the print server 2 via the public network 7. In other cases, it is possible that the inkjet printer 1, the print server 2, and the client terminal 3 are connected to the same network.

For example, the networks 4 to 6 are closed networks such as an office local area network (LAN) etc., and the inkjet printer 1, the print server 2, and the client terminal 3 are connected to the public network 7 via each LAN. However, it is possible that the inkjet printer 1, the print server 2, and the client terminal 3 are connected to the public network 7 directly.

In addition, it is possible to implement the networks 4 to 6 using a network compatible with interfaces such as Ethernet, Universal Serial Bus (USB), Bluetooth, Wireless Fidelity (Wi-Fi), FeliCa, and the Institute of Electrical and Electronics Engineers (IEEE) standard etc.

The inkjet printer 1 is a multifunction peripheral (MFP) that can be used as a printer, facsimile, scanner, and copier. The print server 2 performs control, management, and process so that multiple client terminals 3 can share the inkjet printer 1 via the network.

The client terminal 3 is an information processing device such as a personal computer (PC) operated by user operation. It is possible to implement the client terminal 3 using a portable device such as a personal digital assistant (PDA), smartphone, and tablet device etc.

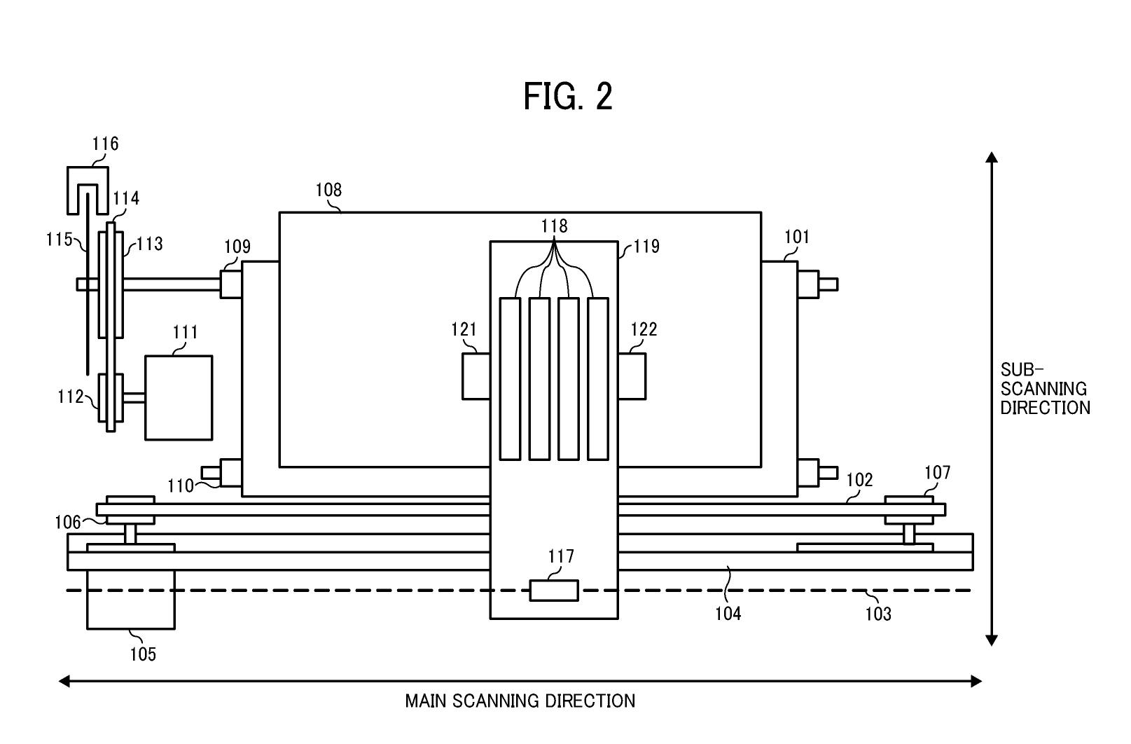

Next, an inside configuration of the inkjet printer 1 from a direction perpendicular to a recording surface in this embodiment is described below with reference to FIG. 2. FIG. 2 is a diagram illustrating an inside configuration of the inkjet printer 1 from a direction perpendicular to a recording surface in this embodiment.

As illustrated in FIG. 2, the inkjet printer 1 in this embodiment includes a conveyance belt 101, a main scanning belt 102, an encoder scale 103, a slide rail 104, a main scanning motor 105, a driving pulley 106, a driven pulley 107, a recording medium 108, a conveyance roller 109, a tension roller 110, a sub-scanning motor 111, a conveyance driving pulley 112, a conveyance roller pulley 113, a sub-scanning belt 114, an encoder wheel 115, an encoder sensor 116, an encoder sensor 117, a recording head 118, and a carriage 119.

A slide rail 104 is a guiding part fixed in parallel with the main scanning direction in FIG. 2 and holds the carriage 119 in the main scanning direction in FIG. 2 slidably. The carriage 119 is held in the main scanning direction in FIG. 2 slidably by the slide rail 104 and moved and scanned by the main scanning motor 105 via the main scanning belt 102 bridged across the driving pulley 106 and the driven pulley 107. That is, here, the slide rail 104 functions as a carriage main scanning slider.

In addition, the carriage 119 includes recording heads 118 that eject ink droplets for each of colors, i.e., yellow (Y), cyan (C), magenta (M), and black (K). Furthermore, the recording head 118 includes four droplet discharge heads independent from each other. It should be noted that it is possible that the recording head 118 includes one droplet discharge head including four rows of nozzle that ejects droplet for each color.

Each of the four droplet discharge heads is laid out in parallel with the sub-scanning direction in FIG. 2. In addition, each of the four droplet discharge heads is laid out in parallel with the main scanning direction in FIG. 2 is mounted on the recording head 118 so that the ink ejecting direction is toward to an area where the recording medium passes.

The droplet discharge head included in the recording head 118 in this embodiment is an inkjet head, and a device that includes a pressure generator generating pressure to eject ink droplets such as a piezoelectric actuator such as a piezoelectric element etc., a thermal actuator that uses phase change by liquid film boiling using electrothermal conversion element such as a heat element, a shape-memory alloy actuator that uses metal phase change due to temperature change, and an electrostatic actuator that uses electrostatic force.

The inkjet printer 1 in this embodiment not only can drive all of the droplet discharge heads in the recording head 118 simultaneously but also can drive all of the droplet discharge heads using time-division. Therefore, it is possible to avoid issues such as deteriorating recording quality due to an effect of crosstalk between droplet discharge heads and increasing capacity of power supply requiring large current temporarily etc. in driving all droplet discharge heads in the recording head 118 simultaneously by driving the droplet discharge heads using time-division.

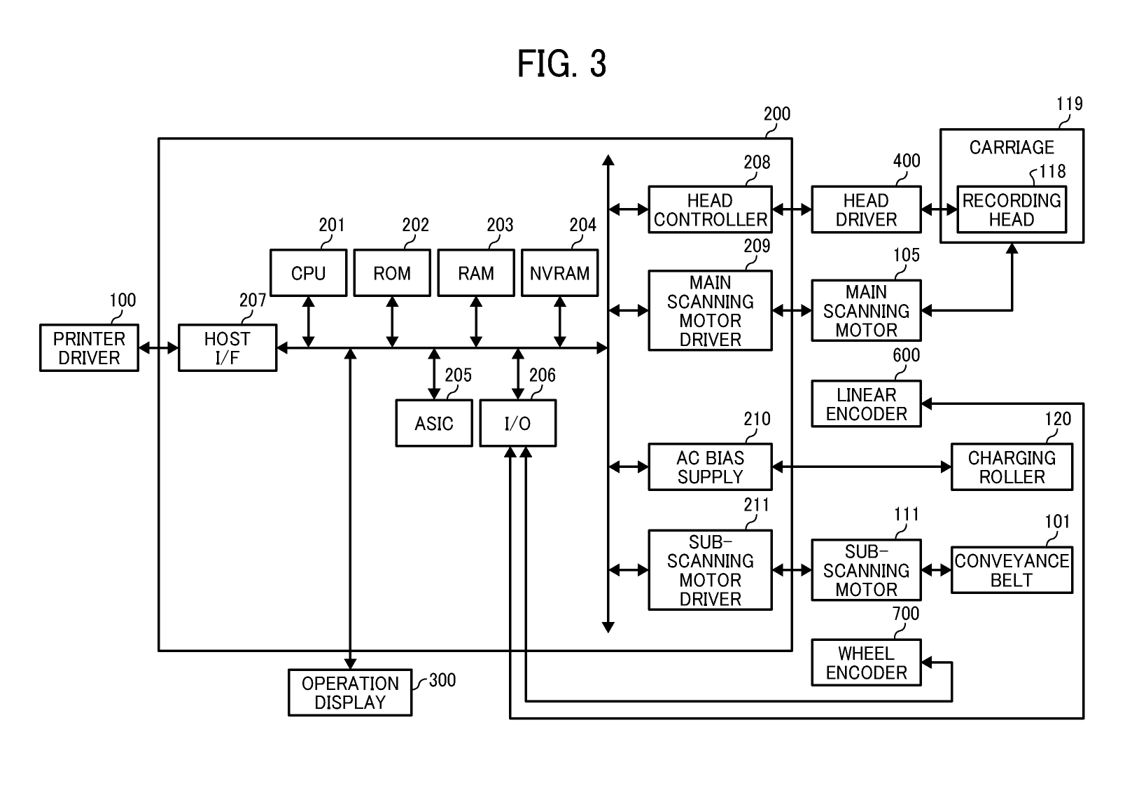

In addition, the recording head 118 in this embodiment includes a driver IC and is connected to the controller 200 in FIG. 3 via a wire harness. The driver IC receives a signal from the controller 200 in FIG. 3 via the wire harness and controls a motor based on the received signal to drive the droplet discharge heads in the recording head 118.

In the inkjet printer 1 in this embodiment, in case of not recording an image, it is possible to cover a nozzle formation surface of each of the droplet discharge heads in the recording head 118 to keep moisture around the nozzle formation surface and prevent the recording liquid from being dried.

In addition, in the inkjet printer 1 in this embodiment, if a cover of the apparatus body is opened in printing an image, it is stopped to print an image temporarily, the carriage 119 is moved to a position of the cap, and cover the nozzle formation surface of each of the droplet discharge heads in the recording head 118. It should be noted it is detected that the cover is opened and closed by using a cover closing sensor.

By adopting the configuration described above, even if the cover of the apparatus body is opened and it is stopped to print an image temporarily, the inkjet printer 1 in this embodiment can keep moisture on the nozzle formation surface, preventing from ejection failure doe to drying of recording liquid droplets in the droplet discharge heads and maintaining stable discharging performance.

If the cover is closed again after the cover is opened, the inkjet printer 1 in this embodiment goes back to the status when it is stopped to print an image and resumes printing from that status.

Furthermore, the carriage 119 includes an encoder sensor 117. The encoder sensor 117 is configured as a linear encoder that detects a position of the carriage 119 in the main scanning direction by detecting slits of the encoder scale 103 laid out in the main scanning direction as illustrated in FIG. 2.

The conveyance belt 101 is an endless belt and bridged across a conveyance roller 109 and a tension roller 110. The conveyance roller 101 moves around in the sub-scanning direction in FIG. 2 by driving the conveyance roller 109 via the sub-scanning belt 114 bridged across a conveyance driving pulley 112 and a conveyance roller pulley 113 using the sub-scanning motor 111.

The inkjet recording apparatus in this embodiment includes a charging roller as a charging unit that charges the surface of the conveyance belt 101. The charging roller contacts the surface layer of the conveyance belt 101 and rotates in accordance with the conveyance belt 101.

It should be noted that the conveyance belt 101 includes one layer structure or multiple layers structure including equal to or more than two layers. In case of the multiple layers structure including two or more layers, the surface that contacts the recording medium 108 and the charging roller is formed by an insulator layer, and the opposite surface is formed by a conductive layer. By contrast, if the conveyance belt 101 is formed using one layer structure, since the conductivity is the same between the surface contacting the recording medium 108 and the charging roller described above and the opposite surface, the whole layer is formed by insulating material. Accordingly, the conveyance roller 109 also functions as a ground roller that works as the ground surface and is laid out so that the conveyance roller 109 contacts the back surface of the conveyance belt 101.

By adopting the configuration described above, the inkjet printer 1 in this embodiment can attract the recording medium 108 on the conveyance belt 101 electrostatically and convey the recording medium 108 to a recording area using the recording head 118.

In this case, on the charging roller described above, alternate voltage that plus voltage and minus voltage repeats is applied alternately by an alternating current (AC) bias supply 210 in FIG. 3. As a result, the conveyance belt 101 is charged alternately in strip-shaped repeating plus and minus at a predetermined width in the sub-scanning direction in FIG. 2. If the recording medium 108 is fed on the charged conveyance belt 101, the recording medium is stuck to the conveyance belt 101 by electrostatic force and conveyed to the sub-scanning direction in FIG. 2 by rotation of the conveyance belt 101.

On the upper back side of the conveyance belt 101, a recording guiding member is located in accordance with a recording area by the recording head 118. The recording guiding member is laid out in parallel with the recording surface by the recording head 118. In addition, the recording guiding member is laid out so that the recording guiding member projects to the side of the recording head 118 over a tangent line of two rollers that supports the conveyance belt 101 (i.e., the conveyance roller 109 and the tension roller 110). By adopting the configuration described above, the conveyance belt 101 can maintain flatness to a high accuracy in the recording area by the recording head 118.

In addition, the inkjet printer 1 in this embodiment includes an encoder sensor 116 to detect a position of the conveyance belt 101 in the sub-scanning direction at a position illustrated in FIG. 2. That is, the encoder sensor 116 is configured as a wheel encoder that detects a position of the conveyance belt 101 in the sub-scanning direction by detecting a slit of the encoder wheel 115 laid out in the same axis as the conveyance roller 109.

As a result, in case of printing an image, first, the inkjet printer 1 stops the recording medium 108 at the position where the recording guiding member is laid out. Subsequently, the inkjet printer 1 ejects ink droplets on the recording medium 108 to record one line by scanning the carriage 119 in the main scanning direction along with the slide rail 104 and driving each droplet discharge head in the recording head 118.

After recording one line, the inkjet printer 1 conveys the recording medium 108 in the sub-scanning direction for a predetermined amount and records next line similarly. Accordingly, after the controller 200 in FIG. 2 receives a recording end signal or a signal indicating that the tail edge of the recording medium 108 in the conveying direction passes by the recording area by the recording head 118, the inkjet printer 1 finishes printing an image and ejects the recording medium 108.

After finishing printing an image, the inkjet printer 1 moves the carriage 119 to the cap position described above and covers the droplet discharge heads in the recording head 118. Each of a first edge detecting sensor 121 and a second edge detecting sensor 122 is a sensor that detects the edge of the recording medium 108 in the main scanning direction.

In this embodiment, in performing frameless printing, the inkjet printer 1 detects edges of the recording medium 108 in the main scanning direction for more than two edges in the sub-scanning direction by the first edge detecting sensor 121 and the second edge detecting sensor 122 and determines the printing area based on the detection result.

More specifically, in performing frameless printing, the inkjet printer 1 in this embodiment estimates a tilt of the recording medium 108 by detecting edges of the recording medium 108 in the main scanning direction for more than two edges in the sub-scanning direction by the first edge detecting sensor 121 and the second edge detecting sensor 122 and determines the printing area based on the estimated tilt.

As a result, it is unnecessary that the inkjet printer 1 in this embodiment always scans the carriage detecting an area where the recording medium exists. Consequently, it is possible that the inkjet printer 1 in this embodiment reduces the processing load in performing frameless printing.

Hereinafter, the operation that estimates the tilt of the recording medium 108 and determines the recording area based on the estimated tilt as described above is referred to as “a tilt calculating operation”, and the function that the inkjet printer 1 implements the operation is referred to as “a tilt calculating function”.

Next, a hardware configuration of the inkjet printer 1 in this embodiment is described below with reference to FIG. 3. FIG. 3 is a block diagram illustrating a hardware configuration of the inkjet printer 1 in this embodiment.

As illustrated in FIG. 3, the inkjet printer 1 in this embodiment includes a printer driver 100, a conveyance belt 101, a main scanning motor 105, a sub-scanning motor 111, a recording head 118, a carriage 119, a charging roller 120, a controller 200, an operation display 300, a head driver 400, a linear encoder 600, and a wheel encoder 700.

The printer driver 100 generates print data on host apparatuses such as an information processing terminal such as a personal computer (PC) etc., an image scanning apparatus such as an image scanner etc., and an image capturing apparatus such as a digital camera etc. and inputs the generated print data to the controller 200.

The controller 200 includes a central processing unit (CPU) 201, a read only memory (ROM) 202, a random access memory (RAM) 203, a non-volatile RAM (NVRAM) 204, an application specific integrated circuit (ASIC) 205, an input/output (I/O) 206, a host interface (I/F) 207, a head controller 208, a main scanning driver 209, an AC bias supply 210, and a sub-scanning motor driver 211.

The CPU 201 is a processing unit and controls the entire inkjet printer 1. The ROM 202 is a read-only non-volatile storage medium and stores programs such as firmware.

The RAM 203 is a volatile memory that can read/write information at high speed and is used as a work area when the CPU 201 processes information. The NVRAM 204 is a non-volatile storage medium that can read/write information and stores the operating system (OS), various control programs, and application programs etc.

The ASIC 205 includes various interfaces that control the entire inkjet printer 1, include an image processing circuit, and include a circuit that controls input/output of the image data, and the CPU 201 controls the ASIC 205. That is, the ASIC 205 processes various signals for the image data, processes images sorting data etc. and processes input/output signals to control the entire inkjet printer 1.

The I/O 206 inputs detection pulses from the linear encoder 600 and the wheel encoder 700 and detection signals from the first edge detecting sensor 121 and the second edge detecting sensor 122 to the controller 200. In addition, the I/O 206 input detection signals from other various sensors to the controller 200. The host I/F 207 exchanges data with the host apparatus described above via the network or the USB cable etc.

The head controller 208 generates driving waveforms to drive each of the droplet discharge heads in the recording head 118 and outputs image data that drives the pressure generator in each of the droplet discharge heads selectively along with various data to the head driver 400. The main scanning motor driver 209 drives the main scanning motor 105. The AC bias supply unit 210 supplies AC bias to the charging roller. The sub-scanning motor driver 211 drives the sub-scanning motor 111.

The operation display 300 is a user interface to input data to the inkjet printer 1 and is implemented by input devices such as a keyboard, a mouse, an input button, and a touch panel etc.

In addition, the operation display 300 is a visual user interface for checking a status of the inkjet printer 1 and implemented by a display device such as a liquid crystal display (LCD) and an output device such as a light emitting diode (LED) etc.

The head driver 400 drives each of the droplet discharge heads in the recording head 118 by applying the drive pulse that comprises the drive waveform sent from the drive waveform generator in the head controller 208 based on image data (dot pattern data) corresponding to one line of the recording head 118 input serially to the pressure generator in the recording head 118 selectively.

A driving waveform generator in the head controller 208 described above consists of a digital-analog converter that performs digital-analog conversion on pattern data of a driving pulse stored in the ROM 202 and an amplifier etc. and outputs a drive waveform comprised of one drive pulse or multiple drive pulses to the head driver 400.

For example, the head driver 400 includes a shift register that a clock signal and serial data as the image data is input, a latch circuit that latches the register value of the shift register at a latch signal, a level shifter that shifts the output value of the latch circuit, and an analog switch array (switching unit) that is controlled turning on and off by the level shifter.

Accordingly, by controlling turning on and off the analog switch array described above, the head driver 400 applies a predetermined driving pulse included in the drive waveform selectively to the pressure generator in each of the droplet discharge heads in the recording head 118.

In accordance with the signal from the main scanning motor driver 209, the main scanning motor 105 moves and scans the carriage 119 along with the slide rail 104, i.e., in the main scanning direction in FIG. 2 via the main scanning belt 102. In accordance with the signal from the sub-scanning motor driver 211, the sub-scanning direction 111 moves and transfers the conveyance belt 101 in the sub-sub-scanning direction in FIG. 2 by rotating and driving the conveyance roller 109 via the sub-sub-scanning belt 114.

By adopting the configuration described above, in the inkjet printer 1 in this embodiment, the CPU 201 reads and analyze the print data in the receiving buffer received by the host I/F 207, processes the required image and sorts data etc. using the ASIC 205 to transfer the processed data to the head controller 208, and outputs the image data and the drive waveform from the head controller 208 to the head driver 400 at predetermined timing.

For example, it is possible to generate dot pattern data for outputting an image by storing font data in the ROM 202 or expanding the image data into bitmap data by the printer driver in the host to transfer the expanded bitmap data to the controller 200. In FIG. 2, the printer driver 100 generates the dot pattern data for outputting an image.

In this hardware configuration described above, programs stored in storage devices such as the ROM 202 and the NVRAM 204 etc. are read to the RAM 203, and a software controlling unit is constructed by executing operation in accordance with the loaded programs in the RAM 203 by the CPU 201. Functional blocks that implement capabilities of the inkjet printer 1 of this embodiment are constructed by a combination of the software controlling units described above and hardware.

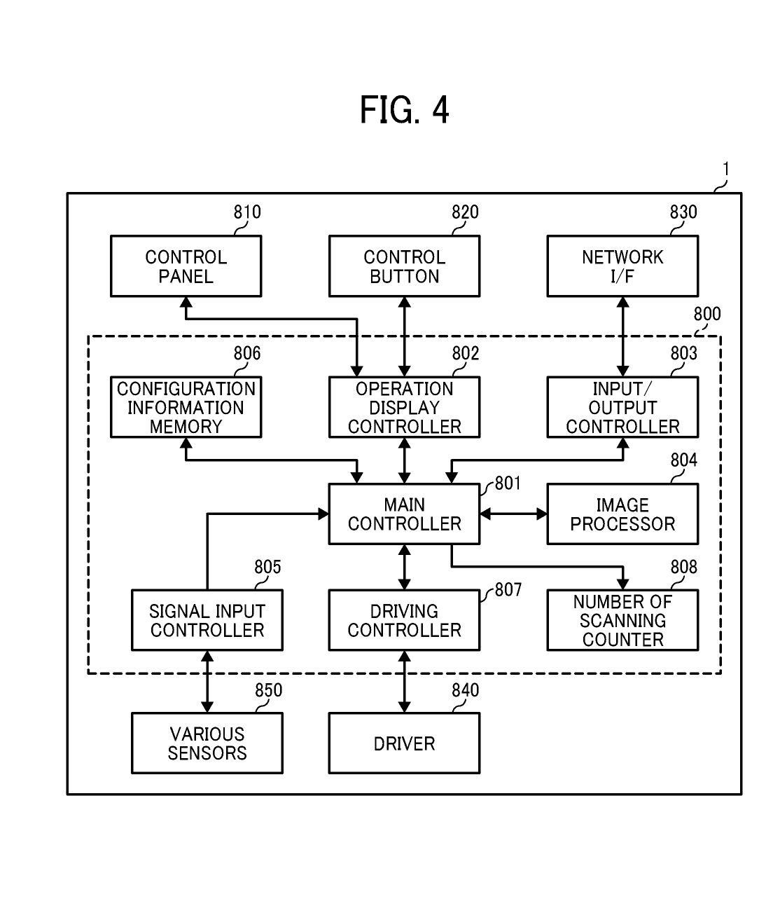

Next, a functional configuration of the inkjet printer 1 in this embodiment is described below with reference to FIG. 4. FIG. 4 is a block diagram illustrating a functional configuration of the inkjet printer in this embodiment.

As illustrated in FIG. 4, the inkjet printer 1 in this embodiment includes a controller 800, a control panel 810, a control button 820, a network I/F 830, and a driver 840. The controller 800 includes a main controller 801, an operation display controller (display control unit) 802, an input/output controller 803, an image processor 804, a signal input controller 805, a configuration information memory 806, and a driving controller 807.

The control panel 810 is an output interface that displays the status of the inkjet printer 1 visually and an input interface that the inkjet printer 1 is operated directly as a touch panel by user operation or information is input into the inkjet printer 1 by user operation. That is, the control panel 810 includes a function that displays images to accept user operation.

The control button 820 is an input interface that the inkjet printer 1 is operated directly by user operation or information is input into the inkjet printer 1 by user operation. The network I/F 830 is an interface to communicate with information processing apparatuses such as the PC by user operation.

The driver 840 is a driving unit such as a motor and actuator that operate in the inkjet printer 1. The various sensors 850 are various sensors such as the first edge detecting sensor 121, the second edge detecting sensor 122, the linear encoder 600, and the wheel encoder 700 etc.

The controller 800 is implemented by a combination of software and hardware. That is, the controller 800 is constructed by a software controlling unit is constructed, after reading programs stored in storage devices such as the ROM 202 and the NVRAM 204 etc. to the RAM 203 by the CPU 201, by executing operation in accordance with the loaded programs by the CPU 201 and hardware such as integrated circuits etc.

The main controller 801 controls each unit included in the controller 800 and commands each unit in the controller 800.

The operation display controller 802 displays information on the control panel 810 and reports information input via the control panel 810 to the main controller 801. Subsequently, the main controller 801 passes commands to each unit in the controller 800 in accordance with the information reported by the operational display controller 802.

The input/output controller 803 inputs signals and commands input via the network I/F 830 to the main controller 801. Subsequently, the main controller 801 passes commands to each unit in the controller 800 in accordance with the information input from the input/output controller 803.

The image processor 804 generates drawing information as output information under control of the main controller 801 based on image information written in Page Description Language (PDL) etc. such as document data and image data included in the input print job for example. The drawing information is information such as bitmap data etc. of CMYK and information to draw an image to be formed in the image forming operation by the inkjet printer 1.

The signal input controller 805 inputs detection signals and measurement signal input from the various sensors 850 such as the first edge detecting sensor 121, the second edge detecting sensor 122, the linear encoder 600, and the wheel encoder 700 etc. to the main controller 801. Subsequently, the main controller 801 commands each unit in the controller 800 based on the detection signals and measurement signals input from the signal input controller 805.

The configuration information memory 806 stores configuration information that the inkjet printer 1 requires to operate. The drive controller 807 controls the driver 840 under control of the main controller 801. The number of scanning counter 803 records the counter value N as the number of scanning the carriage 119 in printing under control of the main controller 801.

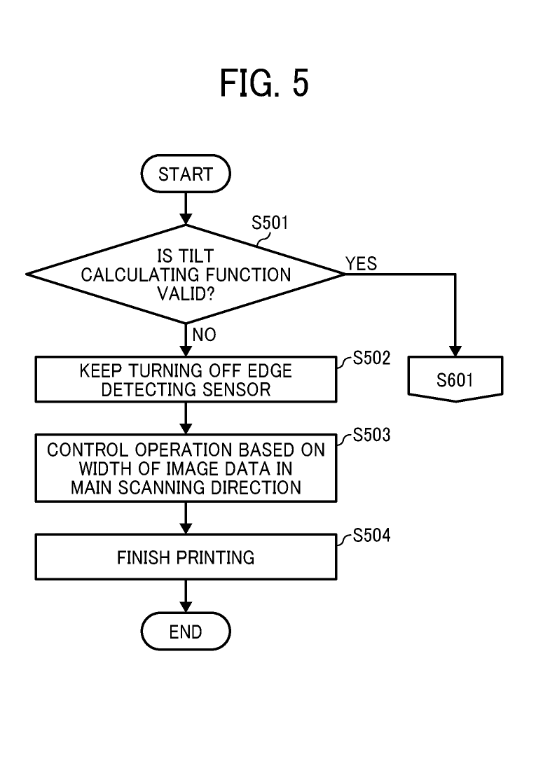

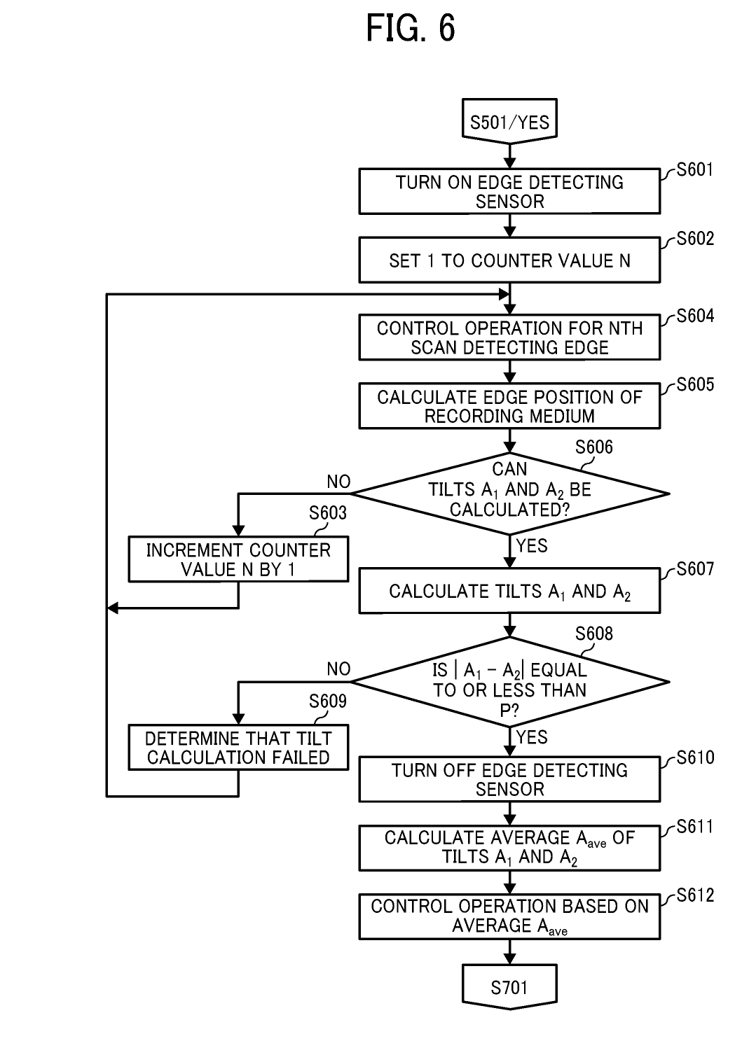

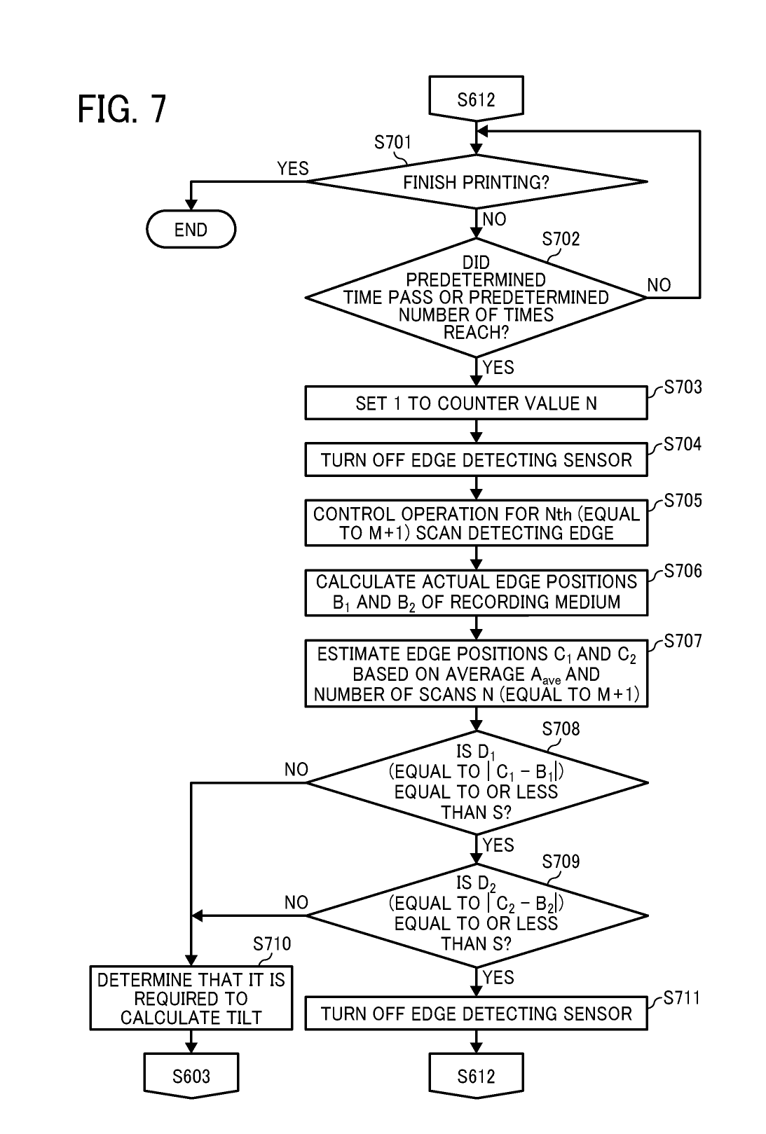

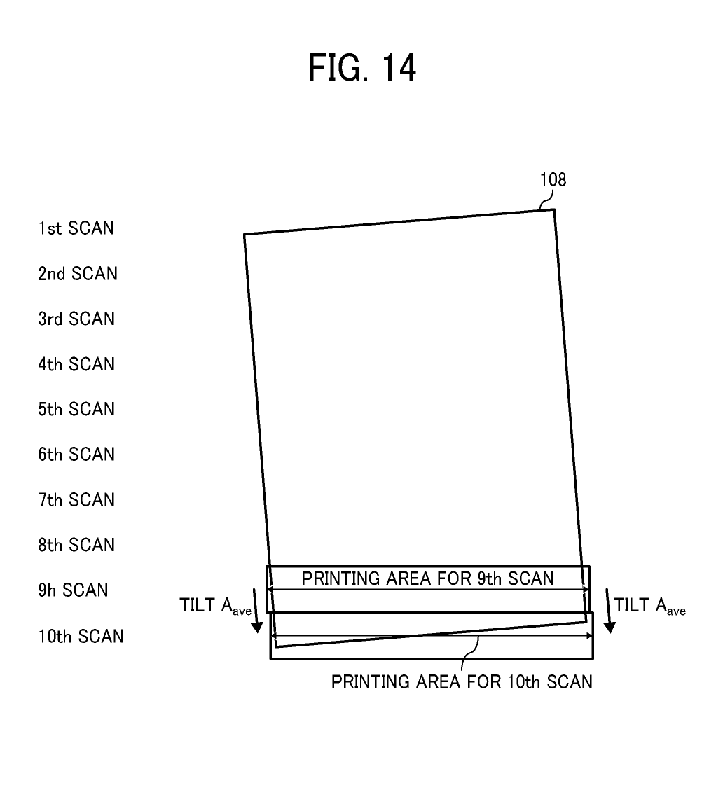

Next, an operation of performing frameless printing by the inkjet printer 1 in this embodiment is described below with reference to FIGS. 5 to 14.

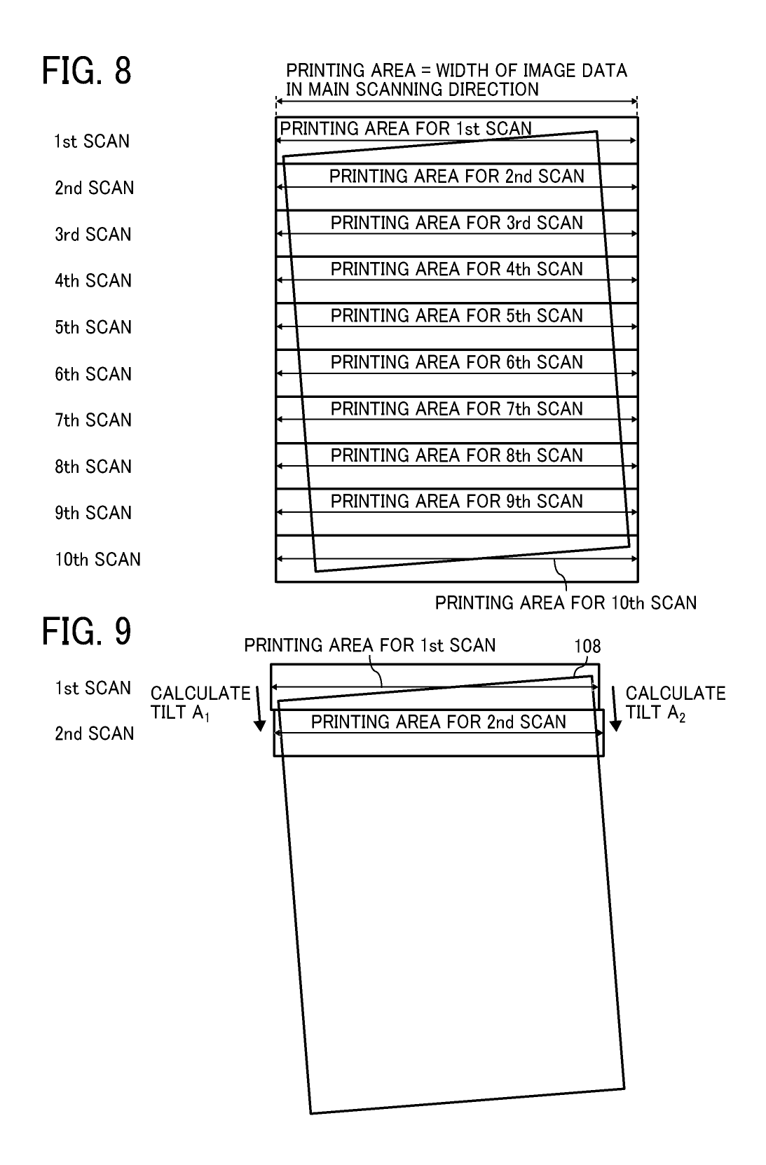

FIGS. 5 to 7 are flowcharts illustrating an operation that the inkjet printer 1 performs frameless printing in this embodiment. FIGS. 8 to 14 are diagrams illustrating an operation that the inkjet printer 1 performs frameless printing in this embodiment.

In performing frameless printing, in the inkjet printer 1 in this embodiment, the main controller 801 checks configuration information stored in the configuration information memory 806 and determines whether or not the tilt calculating function is valid in S501.

If the main controller 801 determines that the tilt calculating function is configured as invalid (NO in S501), the first edge detecting sensor 121 and the second edge detecting sensor 122 are kept turned off in S502, and the carriage 119 is controlled so that the printing area corresponds to the width of the image data in the main scanning direction as illustrated in FIG. 8 in S503. Subsequently, after finishing printing, the main controller 801 finishes the operation of performing frameless printing.

By contrast, if the main controller 801 determines that the tilt calculating function is configured as valid (YES in S501), the first edge detecting sensor 121 and the second edge detecting sensor 122 are turned on in S601, and the counter value N of the number of scanning counter 808 is set to 1 in S602.

Subsequently, as illustrated in FIG. 9, the main controller 801 controls the Nth scanning operation of the carriage 119 detecting the edge of the recording medium 108 in the main scanning direction using the first edge detecting sensor 121 and the second edge detecting sensor 122 so that the printing area corresponds to the width of the recording medium 108 in the main scanning direction in S604. That is, in this embodiment, the first edge detecting sensor 121 and the second edge detecting sensor 122 function as an edge detector.

In this case, simultaneously, the main controller 801 calculates a position in the main scanning direction of the edge of the recording medium 108 in the main scanning direction (hereinafter referred to as “edge position”) based on the detection result of the edge of the recording medium 108 in the main scanning direction by the first edge detecting sensor 121 and the second edge detecting sensor 122 in S605.

Next, in S606, the main controller 801 determines whether or not it is possible to calculate tilts A₁ and A₂ of the recording medium based on moving distance of the carriage 119 in the sub-sub-scanning direction and the position of the edge of the recording medium 108 calculated in S605. That is, in this embodiment, the main controller 801 functions as a tilt calculator.

In this case, the tilt of the recording medium 108 in the main scanning direction on one end is considered as A₁ and the tilt of the recording medium 108 in the main scanning direction on the other end is considered as A₂.

In S606, if it is determined that it is impossible to calculate the tilts A₁ and A₂ of the recording medium 108 (NO in S606), the main controller 801 increments the counter value N of the number of scanning counter 808 by 1 in S603, and the operation after S604 is performed similarly.

By contrast, if it is determined that it is possible to calculate the tilts A₁ and A₂ of the recording medium 108 (YES in S606), as illustrated in FIG. 9, the tilts A₁ and A₂ of the recording medium 108 is calculated in S607.

Next, the main controller 801 determines whether or not the difference between A₁ and A₂ calculated in S607 is equal to or less than a predetermined value P, i.e., it is determined whether or not |A₁−A₂|≦P in S608.

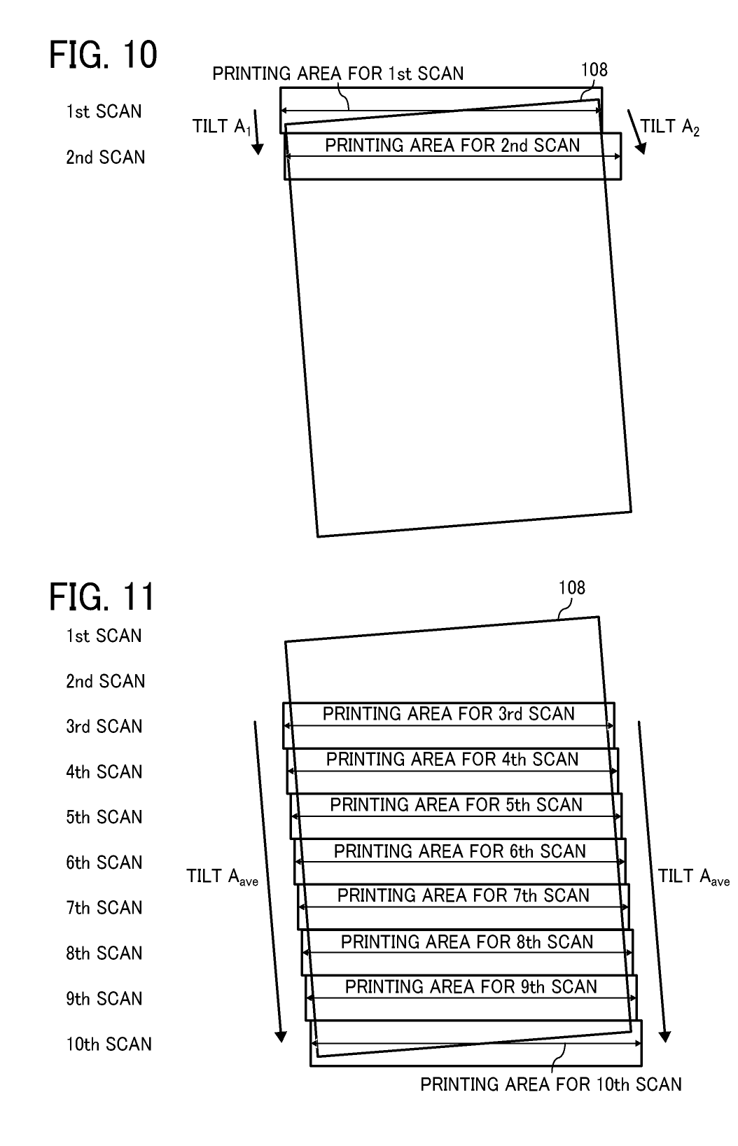

If it is determined that |A₁−A₂|>P in S608 (NO in S608), as illustrated in FIG. 10, since A₁ is extremely different from A₂, it is determined that there was an error in calculating tilt in S609, the counter value N of the number of scanning counter 808 is incremented by 1 in S603, and the operation after S604 is performed similarly.

As described above, if it is determined that |A₁−A₂|>P, the inkjet printer 1 in this embodiment calculates tilt again after the subsequent scanning. As a result, the inkjet printer 1 in this embodiment can calculate tilt of the recording medium 108 precisely.

As described above, if it is determined that |A₁−A₂|>P, the inkjet printer 1 in this embodiment determines that there was an error in calculating tilt since A₁ is extremely different from A₂ and calculates tilt again after the subsequent scanning.

Otherwise, if it is determined that |A₁−A₂|>P, the inkjet printer 1 in this embodiment can determine that there was an error in calculating tilt since A₁ is extremely different from A₂ the inkjet printer 1, and it is possible to control the carriage 119 so that the printing area corresponds to the width of the image data in the main scanning direction as illustrated in FIG. 8 just like the operation in S503 after the subsequent scanning.

By configuring the inkjet printer 1 in this embodiment as described above, it is possible to maintain frameless printing even if A₁ is extremely different from A₂.

By contrast, if it is determined that |A₁−A₂|≦P in S608 (YES in S608), the first edge detecting sensor 121 and the second edge detecting sensor 122 are turned off in S610, and in S611, an average value Aₐᵥₑ average of A₁ and A₂ calculated in S607 is calculated.

Next, as illustrated in FIG. 11, the main controller 801 controls the carriage 119 after subsequent scanning in S612 assuming that the tilt of the recording medium 108 is the average value Aₐᵥₑ calculated in S611. In this case, the main controller 801 updates the counter value N of the number of scanning counter 808 as needed. That is, in this embodiment, the main controller 801 functions as a recording area determination unit (determining unit).

As described above, the inkjet printer 1 in this embodiment controls the carriage 119 after subsequent scanning assuming that the tilt of the recording medium 108 is the average value Aₐᵥₑ average of A₁ and A₂.

As a result, even if the recording medium 108 is folded or is not cut precisely so that the tilt A₁ is different from the tilt A₂, it is possible to calculate the tilt of the recording medium 108 appropriately. As a result, the inkjet printer 1 in this embodiment can calculate tilt of the recording medium 108 precisely.

In addition, as described above, in performing frameless printing, the inkjet printer 1 in this embodiment detects edges of the recording medium 108 in the main scanning direction for more than two edges in the sub-scanning direction by the first edge detecting sensor 121 and the second edge detecting sensor 122 and determines the printing area based on the detection result.

More specifically, in performing frameless printing, the inkjet printer 1 in this embodiment estimates a tilt of the recording medium 108 by detecting edges of the recording medium 108 in the main scanning direction for more than two edges in the sub-scanning direction by the first edge detecting sensor 121 and the second edge detecting sensor 122 and determines the printing area based on the estimated tilt.

By configuring the inkjet printer 1 in this embodiment as described above, it is unnecessary that the inkjet printer 1 in this embodiment always scans the carriage detecting an area where the recording medium exists. Consequently, it is possible that the inkjet printer 1 in this embodiment reduces the processing load in performing frameless printing.

Next, after finishing printing (YES in S701), the main controller 801 finishes the operation of performing frameless printing.

By contrast, before finishing printing (NO in S701), the main controller 801 determines whether or not predetermined time elapses after starting printing or the number of scanning the carriage 119 reaches a predetermined number of times in S702.

If it is determined that the predetermined time does not elapse after starting printing or the number of scanning the carriage 119 does not reach the predetermined number of times (NO in S702), the main controller 801 repeats the determining operation in steps S701 and S702 until it is finished to print.

By contrast, if it is determined that the predetermined time elapses after starting printing or the number of scanning the carriage 119 reaches the predetermined number of times (YES in S702), the main controller 801 increments the counter value N of the number of scanning counter 808 by 1 in S703 and turns on the first edge detecting sensor 121 and the second edge detecting sensor 122 in S704.

Next, the main controller 801 controls the Nth (i.e., equal to M+1) scanning operation of the carriage 119 detecting the edge of the recording medium 108 in the main scanning direction using the first edge detecting sensor 121 and the second edge detecting sensor 122 so that the printing area corresponds to the width of the recording medium 108 in the main scanning direction in S705. It should be noted the number of scanning operation of the carriage 119 when the predetermined time elapses after starting printing or the number of scanning operation of the carriage 119 reaches the predetermined number of times is considered as M in this case.

In this case, simultaneously, the main controller 801 calculates edge positions B₁ and B₂ of the recording medium 108 based on the detection result of the edges of the recording medium 108 in the main scanning direction using the first edge detecting sensor 121 and the second edge detecting sensor 122 in S706. Here, it should be noted that the edge position of the recording medium 108 in the main scanning direction on one end is considered as the edge potion B₁ and the edge position of the recording medium in the main scanning direction on one end is considered as the edge position B₂.

Next, based on the average value Aₐᵥₑ calculated in S611 and the number of scanning operations of the carriage 119 N (i.e., equal to M+1) at that point, the edge positions C₁ and C₂ of the recording medium 108 at the same position in the sub-scanning direction against the carriage 119 is estimated in S707. That is, in this embodiment, the main controller 801 functions as an edge position estimating unit. Here, it should be noted that the edge position of the recording medium 108 on one end is considered as the edge position C₁ and the edge position of the recording medium 108 on the other end is considered as the edge position C₂.

Next, the main controller 801 determines whether or not difference D₁ between the actual edge position B₁ calculated in S706 and the edge position C₁ estimated in S707 and difference D₂ between the actual edge position B₂ calculated in S706 and the edge position C₂ estimated in S707 are equal to or less than a predetermined value S, i.e., whether or not D₁=|C₁−B₁|≦S and D₂=|C₂−B₂|≦S in S708 and S709.

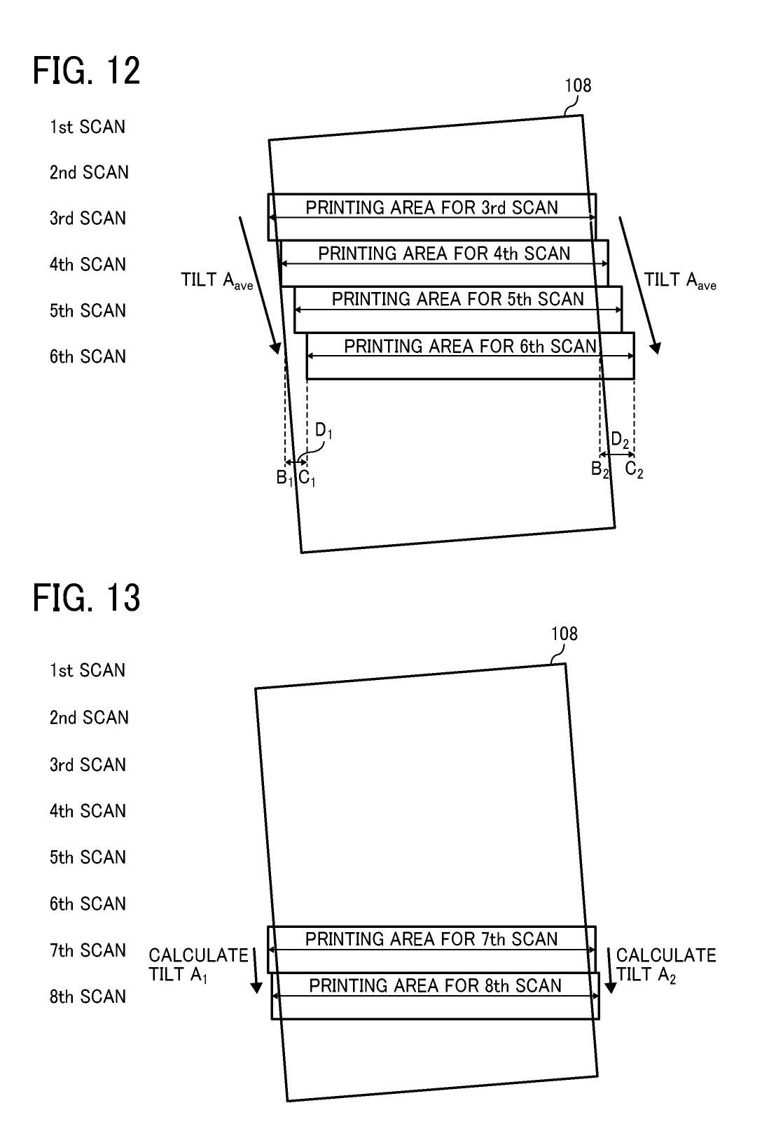

If it is determined that D₁=|C₁−B₁|>S in S708 (NO in S708) and D₂=|C₂−B₂|>S in S709 (NO in S709), as illustrated in FIG. 12, the main controller 801 determines that it is required to perform the tilt calculating operation again in S710 since the actual position of the recording medium 108 is extremely different from the estimated position of the recording medium 108.

Next, as illustrated in FIG. 13, the main controller 801 performs the tilt calculating operation again after subsequent scanning. Subsequently, the main controller 801 controls the operation of the carriage 119 after subsequent scanning (i.e., the main controller 801 performs the same operation as the operation after S603) assuming that the tilt of the recording medium 108 corresponds to the tilt Aₐᵥₑ calculated again.

As described above, if it is determined that D₁=|C₁−B₁|>S or D₂=|C₂−B₂|>S, the inkjet printer 1 in this embodiment calculates tilt again after the subsequent scanning.

As a result, the inkjet printer 1 in this embodiment can calculate the average value Aₐᵥₑ so that the difference between the actual position and the estimated position of the recording medium 108 always falls into the predetermined value S. As a result, the inkjet printer 1 in this embodiment can calculate the tilt of the recording medium 108 precisely.

As described above, if it is determined that D₁=|C₁−B₁|>S or D₂=|C₂−B₂|>S, the inkjet printer 1 in this embodiment determines that it is required to perform the tilt calculating operation again since A₁ is extremely different from A₂ and calculates the tilt again after the subsequent scanning.

Otherwise, if it is determined that D₁=|C₁−B₁|>S or D₂=|C₂−B₂|>S, the inkjet printer 1 in this embodiment can determine that there was an error in calculating tilt since the actual position of the recording medium 108 is extremely different from the estimated position of the recording medium 108, and it is possible to control the carriage 119 so that the printing area corresponds to the width of the image data in the main scanning direction as illustrated in FIG. 8 just like the operation in S503 after the subsequent scanning.

By configuring the inkjet printer 1 in this embodiment as described above, it is possible to maintain frameless printing even if the actual position of the recording medium 108 is extremely different from the estimated position of the recording medium 108.

By contrast, if it is determined that D₁=|C₁−B₁|>S (YES in S708) and D₂=|C₂−B₂|>S (YES in S709), the first edge detecting sensor 121 and the second edge detecting sensor 122 are turned off in S711, and the main controller 801 performs the same operation as the operation after S612.

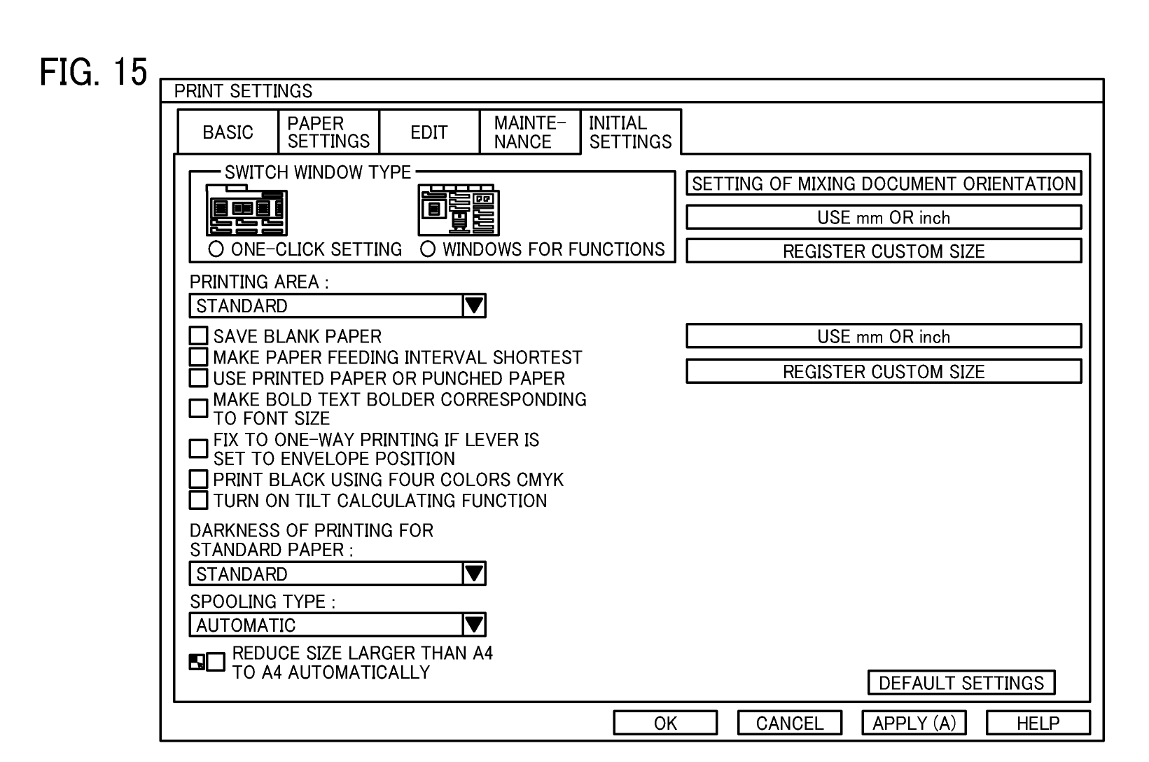

Next, a screen for configuring printing provided by the printer driver 100 in this embodiment is described below. FIG. 15 is a diagram illustrating a screen for configuring printing provided by the printer driver 100 in this embodiment. The screen for configuring printing is displayed on a monitor of the client terminal 3 on which the printer driver 100 is installed.

As illustrated in FIG. 15, the printer driver 100 in this embodiment displays a check box to set the tilt calculating function valid or invalid on the screen for configuring printing and turns the tilt calculating function either valid or invalid in accordance with the user operation on the client terminal 3.

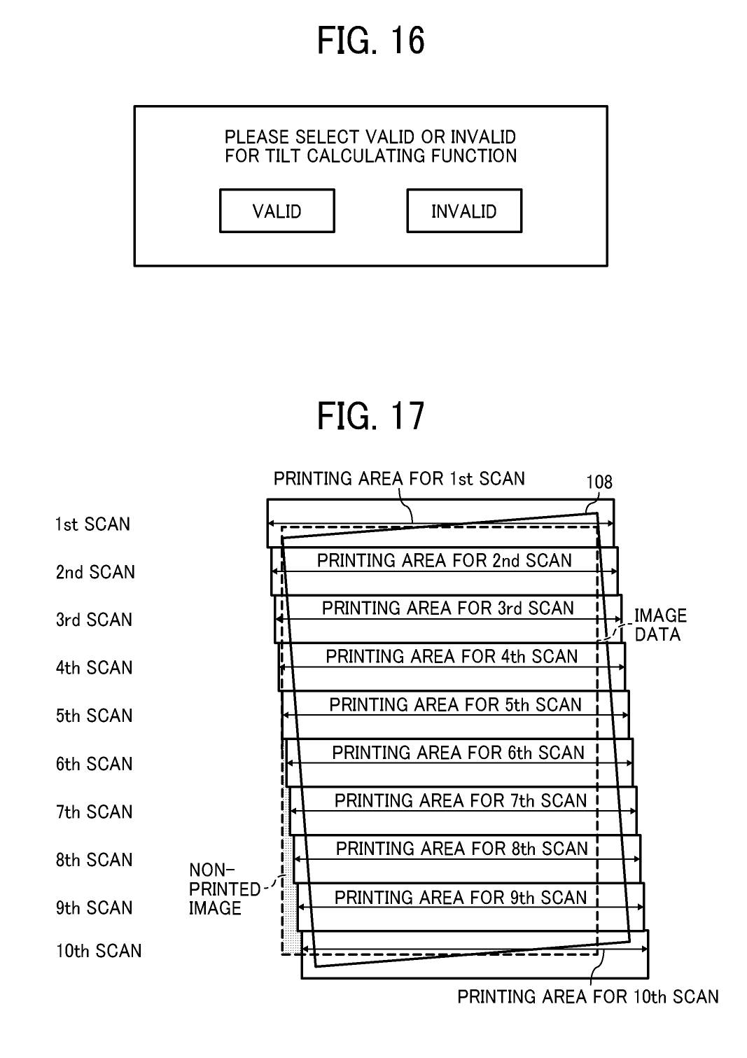

Next, a screen for configuring the tilt calculating function displayed on the control panel 810 by the inkjet printer 1 in this embodiment is described below with reference to FIG. 16. FIG. 16 is a diagram illustrating a screen for configuring a tilt calculating function displayed on the control panel 810 by the inkjet printer 1 in this embodiment.

As illustrated in FIG. 16, the inkjet printer 1 in this embodiment displays a logic button to set the tilt calculating function valid or invalid as the screen for configuring the tilt calculating function on the control panel 810 and turns the tilt calculating function either valid or invalid in accordance with the user operation.

As described above, in performing frameless printing, the inkjet printer 1 in this embodiment detects edges of the recording medium 108 in the main scanning direction for more than two edges in the sub-scanning direction by the first edge detecting sensor 121 and the second edge detecting sensor 122 and determines the printing area based on the detection result.

More specifically, in performing frameless printing, the inkjet printer 1 in this embodiment estimates a tilt of the recording medium 108 by detecting edges of the recording medium 108 in the main scanning direction for more than two edges in the sub-scanning direction by the first edge detecting sensor 121 and the second edge detecting sensor 122 and determines the printing area based on the estimated tilt.

By configuring the inkjet printer 1 in this embodiment as described above, it is unnecessary that the inkjet printer 1 in this embodiment always scans the carriage detecting an area where the recording medium exists. Consequently, it is possible that the inkjet printer 1 in this embodiment reduces the processing load in performing frameless printing.

As described above with reference to FIG. 9, in this embodiment, the inkjet printer 1 that calculates the tilt of the recording medium 108 based on the detection result of both edges of the recording medium 108 in the main scanning direction at the first scanning and the second scanning is described.

Other than that, the inkjet printer 1 in this embodiment can calculate the tilt of the recording medium 108 based on the detection result of both edges of the recording medium 108 in the main scanning direction at the ath scanning and the a+b scanning. Here, it should be noted that a and b are natural numbers equal to or more than 1.

As described above with reference to FIG. 2, in this embodiment, the inkjet printer 1 that includes the first edge detecting sensor 121 and the second edge detecting sensor 122 each on both ends of the carriage 119 in the main scanning direction is described.

Other than that, in this embodiment, the inkjet printer 1 can include the multiple first edge detecting sensors 121 and the multiple second edge detecting sensors 122 on both ends of the carriage 119 in the main scanning direction. By configuring the inkjet printer 1 in this embodiment as described above, it is possible to calculate the tilt of the recording medium 108 by scanning the carriage 119 over the recording medium 108 only once.

In addition, as described above with reference to FIG. 2, in this embodiment, the inkjet printer 1 that includes the first edge detecting sensor 121 and the second edge detecting sensor 122 each on both ends of the carriage 119 in the main scanning direction is described.

Other than that, in this embodiment, the inkjet printer 1 can include either the first edge detecting sensor 121 or the second edge detecting sensor 122 on one end of the carriage 119 in the main scanning direction only.

In this case, the inkjet printer 1 in this embodiment can only calculate either the tilt A₁ or the tilt A₂. As a result, the inkjet printer 1 that includes the first edge detecting sensor 121 and the second edge detecting sensor 122 each on both ends of the carriage 119 in the main scanning direction can calculate the tilt of the recording medium 108 more precisely compared to the inkjet printer 1 that includes either the first edge detecting sensor 121 or the second edge detecting sensor 122 on one end of the carriage 119 in the main scanning direction only.

In addition, in this embodiment, the inkjet printer 1 that includes the first edge detecting sensor 121 and the second edge detecting sensor 122 on the carriage 119 is described.

Other than that, in this embodiment, the inkjet printer 1 can include the first edge detecting sensor 121 and the second edge detecting sensor 122 dependent from the carriage 119.

In the first embodiment described above, in performing frameless printing, the inkjet printer 1 estimates the tilt of the recording medium 108 based on the detection results by the first edge detecting sensor 121 and the second edge detecting sensor 122 and determines the printing area based on the estimated tilt.

By configuring the inkjet printer 1 in the first embodiment as described above, it is unnecessary that the inkjet printer 1 in the first embodiment always scans the carriage detecting an area where the recording medium exists. Consequently, it is possible that the inkjet printer 1 in the first embodiment reduces the processing load in performing frameless printing.

However, in the inkjet printer 1 in the first embodiment, if the recording medium 108 is tilted, the printing area is also tilted in accordance with the tilt of the recording medium 108 as illustrated in FIG. 17. Therefore, in some cases, an image to be printed can exist outside the printing area.

As a result, the inkjet printer 1 cannot print that image (hereinafter referred to as “non-printed image”) on the recording medium 108.

If the non-printed image is at least a part of an image that includes important information, utility value of the printed matter is degraded and that may be an obstacle for usage, and it is required to discard the printed matter and perform printing again using the inkjet printer 1. However, if the non-printed image is not at least a part of the image that includes important information, the utility value of the printed matter is not so degraded and that may not be the obstacle for usage, so it is possible to allow to use the printed matter by user operation.

Therefore, if the non-printed image is at least a part of the image including important information, the inkjet printer 1 in this embodiment interrupts printing. By configuring the inkjet printer 1 in this embodiment as described above, it is possible to prevent resources such as ink, recording medium, and electric power etc. from being wasted.

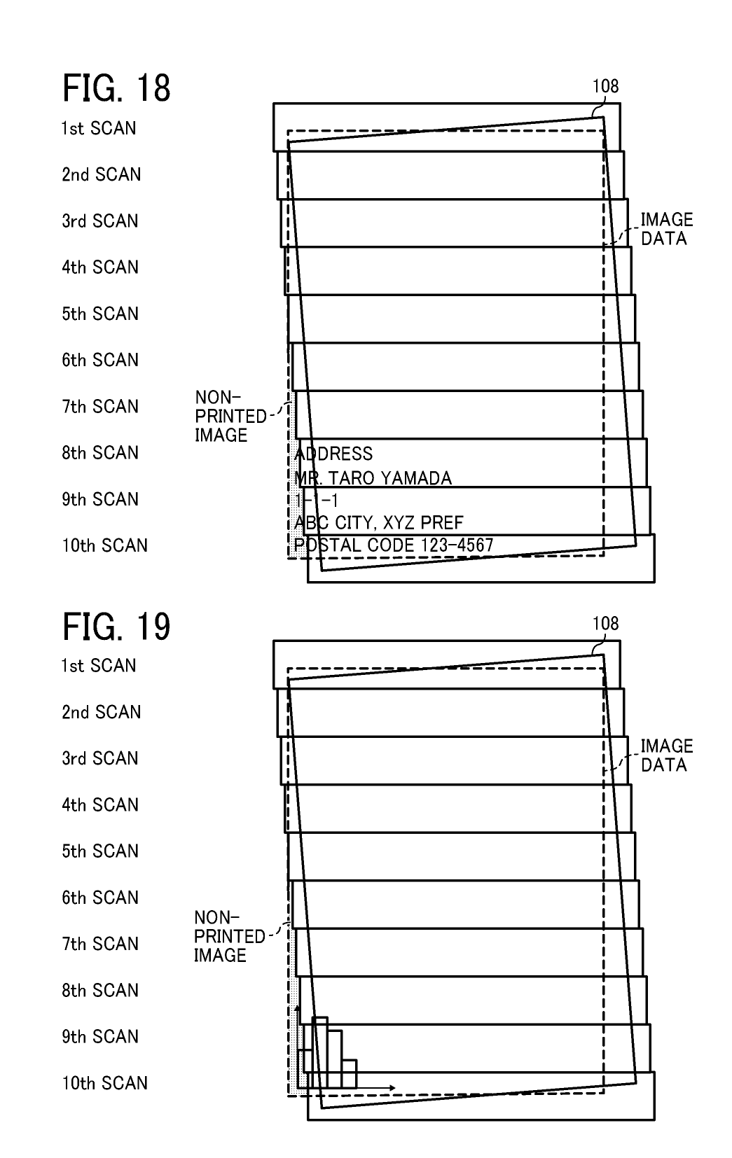

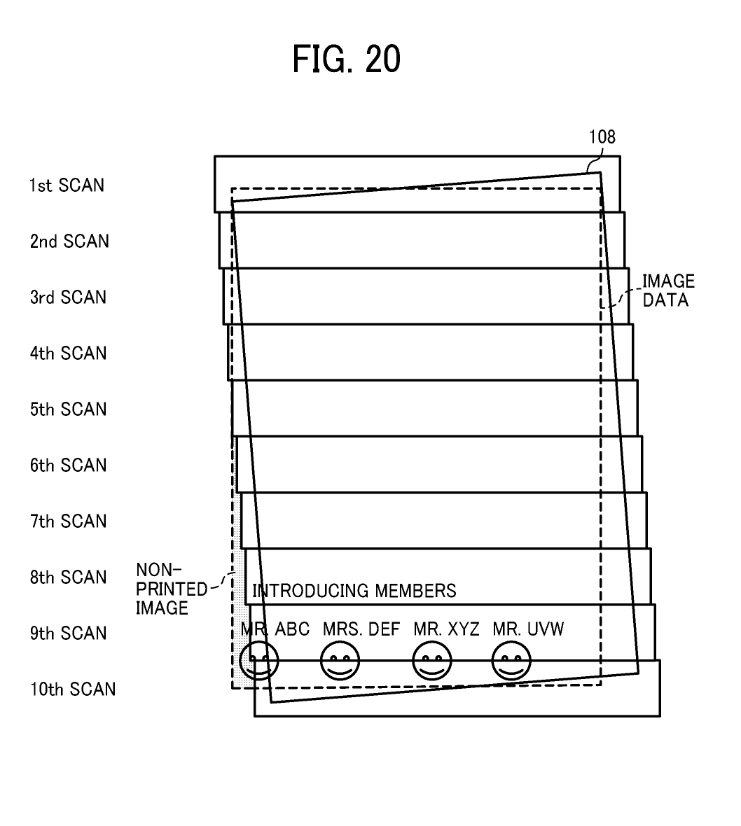

Here, for example, as illustrated in FIGS. 18 to 20, the important information is information that is difficult to suppose a part if at least the part of the information is missed and cannot be shared with other users such as address, name of place, graph, data, and human face etc.

The embodiment is described below in detail with reference to figures. Same symbols are assigned to components corresponding to the embodiment 1, and those descriptions are omitted.

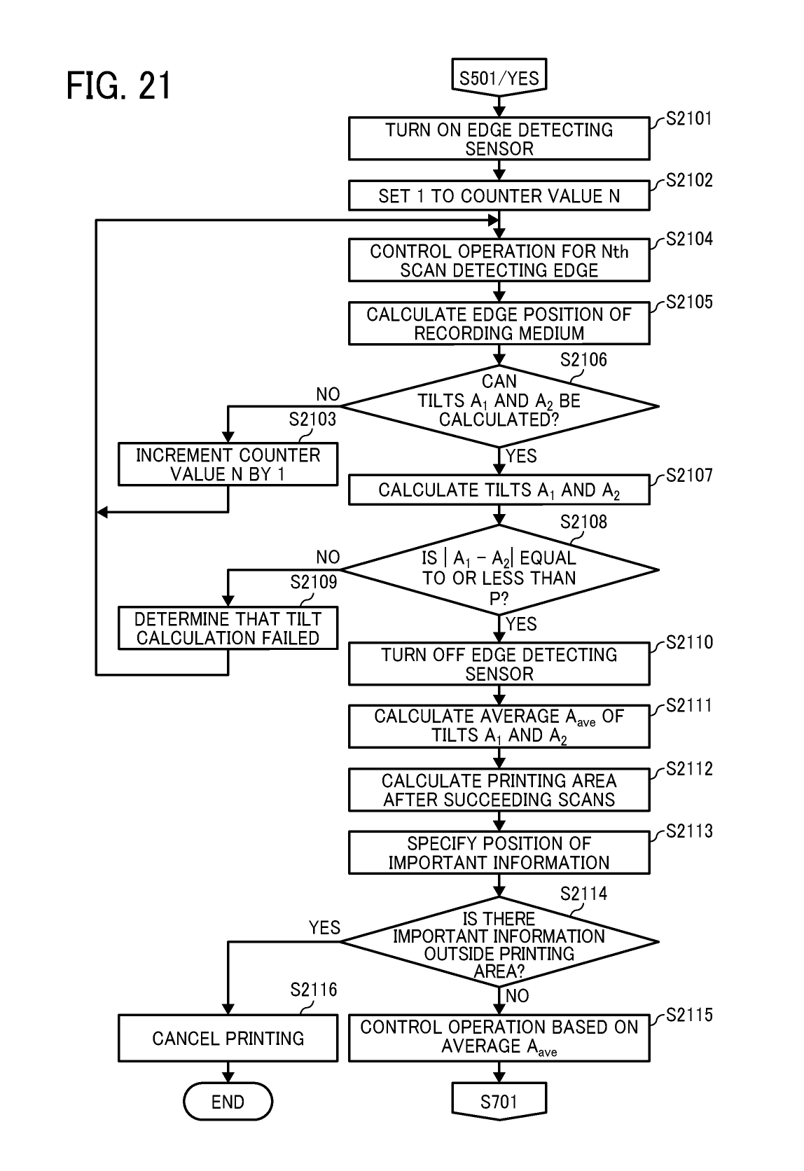

First, an operation of performing frameless printing by the inkjet printer 1 in this embodiment is described below with reference to FIG. 21. FIG. 21 is a flowchart illustrating an operation that the inkjet printer performs frameless printing in this embodiment.

As illustrated in FIG. 21, if the inkjet printer 1 in this embodiment performs frameless printing, first, in S2101 to S2111, the main controller 801 performs the same operation as the operation in steps S601 to S611 if it is determined that the tilt calculating operation is set to valid (YES in S501).

Next, the main controller 801 calculates the printing area after subsequent scanning based on the tilt Aₐᵥₑ calculated in S2111, specifies a position of an image including important information based on the image data in S2113, and determines whether or not at least a part of the image exists outside the printing area in S2114.

If it is determined that no part of the image including the important information exists outside the printing area (NO in S2114), the main controller 801 regards the tilt of the recording medium 108 as the average value Aₐᵥₑ calculated in S2111 and controls the operation of the carriage 119 after the subsequent scanning in S2115. Subsequently, the same operation as the steps after S701 is performed.

By contrast, if it is determined that at least a part of the image including the important information exists outside the printing area (YES in S2114), the main controller 801 interrupts printing in S2116. Subsequently, the operation of performing frameless printing by the inkjet printer 1 in this embodiment ends. That is, in this embodiment, the main controller 801 functions as an operation controller.

As described above, if the non-printed image is at least a part of the image including important information, the inkjet printer 1 in this embodiment interrupts printing. By configuring the inkjet printer 1 in this embodiment as described above, it is possible to prevent resources such as ink, recording medium, and electric power etc. from being wasted.

In the embodiments described above, an inkjet printer that can reduce the processing load in performing frameless printing is provided.

Numerous additional modifications and variations are possible in light of the above teachings. It is therefore to be understood that within the scope of the appended claims, the disclosure of the present invention may be practiced otherwise than as specifically described herein.

For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An image forming apparatus comprising:
a recording head to record an image on an recording medium by repeating operation of ejecting an ink droplet from a nozzle on the recording medium in a sub-scanning direction, while being moved in a main scanning direction with respect to the recording medium;
an edge detector to detect two or more edges in the main scanning direction of the recording medium along the sub-scanning direction; and
circuitry to determine a recording area of the recording medium based on a detection result by the edge detector, the recording area being an area where the image is recorded by the recording head.

2. The image forming apparatus according to claim 1, wherein the circuitry calculates a tilt of the recording medium based on the detection result by the edge detector and determines the recording area based on the calculated tilt.

3. The image forming apparatus according to claim 1, wherein the edge detector detects two or more edges in the main scanning direction of the recording medium along the sub-scanning direction, on one end in the main scanning direction of the recording medium.

4. The image forming apparatus according to claim 1, wherein the edge detector detects two or more edges in the main scanning direction of the recording medium along the sub-scanning direction on both ends in the main scanning direction of the recording medium.

5. The image forming apparatus according to claim 4, wherein the circuitry calculates each tilt on both ends in the main scanning direction of the recording medium based on the detection result by the edge detector and calculates an average value of the calculated tilts as a tilt of the recording medium.

6. The image forming apparatus according to claim 4, wherein the circuitry calculates each tilt on both ends in the main scanning direction of the recording medium based on the detection result by the edge detector and, if a difference between the tilt calculated on one end in the main scanning direction of the recording medium and the tilt calculated on another end in the main scanning direction of the recording medium is equal to or more than a predetermined value, determines the recording area based on image data describing information on an image to be recorded.

7. The image forming apparatus according to claim 2, wherein the circuitry further estimates a position of an edge in the main scanning direction of the recording medium based on the calculated tilt and, for a same position in the sub-scanning direction, if a difference between the estimated position of the edge in the main scanning direction and the position of the edge in the main scanning direction detected by the edge detector is equal to or more than a predetermined value, determines the recording area based on image data describing information on an image to be recorded.

8. The image forming apparatus according to claim 1, wherein the circuitry, if at least a part of an image including information exists outside the determined recording area, interrupts recording the image on the recording medium.

9. A method of forming an image performed by an image forming apparatus, the method comprising:
recording an image on an recording medium by repeating operation of ejecting an ink droplet from a nozzle of a recording head on the recording medium in a sub-scanning direction, while the recording head is moved in a main scanning direction with respect to the recording medium;
detecting two or more edges in the main scanning direction of the recording medium along the sub-scanning direction by an edge detector; and
determining a recording area of the recording medium based on a detection result by the edge detector, the recording area being an area where the image is recorded by the recording head.

10. A non-transitory, computer-readable recording medium storing a program that, when executed by one or more processors of an image forming apparatus, causes the processors to implement a method of forming an image, comprising:
recording an image on an recording medium by repeating operation of ejecting an ink droplet from a nozzle of a recording head on the recording medium in a sub-scanning direction, while the recording head is moved in a main scanning direction with respect to the recording medium;
detecting two or more edges in the main scanning direction of the recording medium along the sub-scanning direction by an edge detector; and
determining a recording area of the recording medium based on a detection result by the edge detector, the recording area being an area where the image is recorded by the recording head.
